(19) United States
(12) Patent Application Publication
(10) Pub. No.: US 2003/0125986 A1
(43) Pub. Date: Jul. 3, 2003

(54) Prescription dispensing device

(76) Inventor: Joseph J. Collosi, Reseda, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/318,872

(22) Filed: Dec. 12, 2002

Related U.S. Application Data
(60) Provisional application No. 60/340,407, filed on Dec. 14, 2001.

(51) Int. Cl. G06F 17/60

(52) U.S. Cl. 705/2; 705/4; 600/300

(57) ABSTRACT

A method and apparatus is disclosed for generating a prescription for medication. The method comprises the steps of inputting patient information and subsequently displaying a list of authorized medications for that patient. The physician selects a specific medication to dispense from the list and enters a number for the required quantity of the medication. A respective prescription for the medication is printed. The prescription includes pertinent information in a readable format as well as in a bar code, wherein the bar code can also include identifiers and encryption keys for anti-forgery and security.

### CROSS-REFERENCE TO RELATED APPLICATIONS

This application claims the benefit of U.S. Provisional Application No. 60/340,407, filed Dec. 14, 2001.

### BACKGROUND OF THE INVENTION

The present invention is directed to the field of physicians dispensing of prescriptions. The invention has particular applicability to the field of transfer of prescription information from a physician's office to a pharmacy for dispensing prescribed medication. In the field of dispensing prescriptions from a physician, certain problems are often encountered. In processing prescription medication at a pharmacy, it can be difficult to validate the information indicated on the physician's prescription. Problems can arise with the accuracy and conformance to standards of a prescription resulting from errors in the transfer of information from physician to pharmacy. Such errors can arise due to legibility and other types of human error. Incorrectly transmitted information can result in improper prescriptions being dispensed, with expense and potential health complications for a patient and possible liability issues for the physician and the pharmacy. Also, a specific brand of prescribed medication may not be authorized by a patient's insurance company. This can result in the expenditure of extra time and effort for all parties involved in rectifying the situation, resulting in frustration and inefficiency.

### SUMMARY OF THE INVENTION

The present invention overcomes the problems of previous methods by providing a method and apparatus comprising a device operating alone or in conjunction with a software implementation. The present invention would essentially provide a physician with a list of approved drugs for the patient based on their individual medical plan. The invention would also provide a patient and a physician with a printed record of the drugs prescribed. Also, a dispensing pharmacy would be provided with a bar-coded script to transfer this information into their system. The present system seeks to provide an accurate, reliable and efficient solution to previous problems, without any external database for compiling patient personal medical information.

The present invention includes a method and apparatus of generating a prescription for medication. The method comprises the steps of inputting patient information and subsequently displaying a list of authorized medications for that patient. The physician selects a specific medication to dispense from the list and enters a number for the required quantity of the medication. A respective prescription for the medication is printed. The prescription includes pertinent information in a readable format as well as in a bar code. The bar code can optionally also include identifiers and encryption keys for anti-forgery and security.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1 depicts a prescription as outputted by a physician using the method and apparatus of the present invention.

FIG. 2 illustrates the bar code as generated for the prescription of the present invention. FIG. 3 shows steps in accomplishing an exemplary method in accordance with the present invention.

### DETAILED DESCRIPTION OF THE INVENTION

The present invention overcomes the problems of previous methods by providing a method and apparatus comprising a hardware device and a software implementation, each operating respectively alone or in conjunction. The present invention would essentially provide a physician with a list of approved drugs for the patient based on their individual medical plan. The invention would also provide a patient and a physician with a printed record of the drugs prescribed. Also, a dispensing pharmacy would be provided with a bar-coded script to transfer this information into their system. The present system seeks to provide an accurate, reliable and efficient solution to previous problems, without any external database for compiling patient personal medical information.

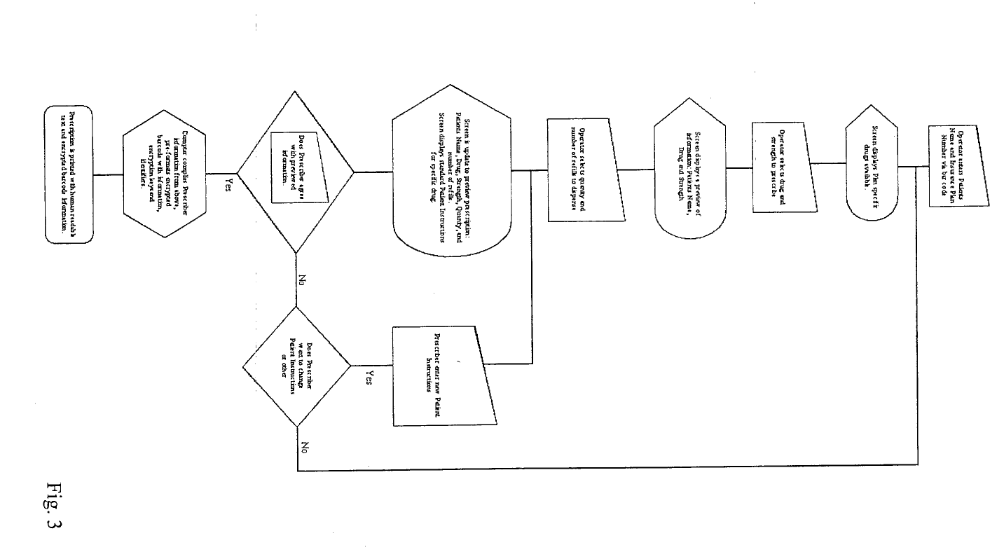

FIG. 3 shows steps in accomplishing an exemplary method in accordance with the present invention. In a prescription dispensing device in accordance with the present invention, patient information such as name and insurance prescription plan number is provided, preferably on a pre-printed bar code, such as is shown in FIG. 2. The bar code could optionally be printed on a health plan card issued by the patient's insurance provider. An operator at a physicians office enters the patient information, preferably by scanning the bar code into a device. The device can optionally be a proprietary hardware device, a computer device operating a software implementation, or any other realization in accordance with the invention. In any case, the device of the present invention includes a display screen that displays an insurance plan specific drug list.

The physician or other operator selects various parameters, such as the specific medication or medications to dispense. In an optional intermediate step, the display screen displays a preview of the patient information, such as the patient name, prescribed drug(s) and strength. This information is then confirmed. The operator then selects a number for the required quantity of each drug, and the number of refills available. At this point, the display screen is updated to preview the prescription and indicate the various parameters, including patient name, drug name(s), drug strength, quantity, and number of refills. The screen can also display the standard patient instructions for the specific drug. Other particular patient-specific information can also be displayed in the even the patient has a known allergy or other condition that would require specific drug usage guidelines. The screen can also include a prompt allowing the operator, physician, or other prescriber to enter new patient information, if required. If the prescriber decides to change the information, the prescriber is prompted to repeat the above-indicated input and confirmation steps. This prescriber is then prompted to confirm the information. If the information is not confirmed, the prescriber is again prompted to repeat the input and confirmation steps. If the prescriber does confirm, a “print” command is issued to print the prescription.

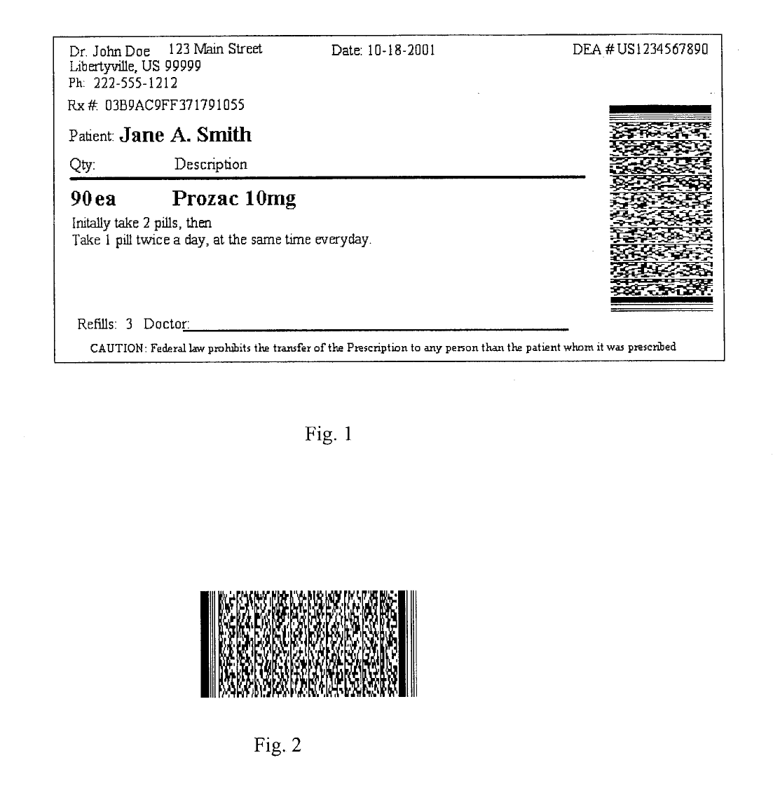

Upon receiving the print command, a prescription is generated in a specific format containing all the pertinent information, as in the exemplary depiction shown in FIG. 1. The prescription can preferably include the following information: the date of dispensing; the physician's name, address, phone number; the physician's DEA number; the patients name; the prescribed drug name, prescribed drug strength, prescribed quantity; specific instructions for the medication; and a unique prescription number. The prescription is then printed in this specific format containing the above-indicated pertinent information. In addition a pre-formatted high-density 2-D bar code (such as a PDF-417 type bar code) will be printed. The bar code is particularly shown in FIG. 2. The bar code will include all information that is human readable on the prescription. Also, other information such as identifiers and encryption keys can be included. Such identification and encryption keys can include anti-forgery and other type security codes, and can include passwords or other codes for enabling access to network databases for validation and other such purposes. Patient medical history information can also be included. Preferably all bar code information is encrypted in a scheme that insures that confidentiality of certain information is maintained between the doctor and the patient. Access to this information can only be extended to the pharmacy, insurance provider, or other third parties through granting of specific access to the encrypted data. In this way, no central database of patient information is maintained that could divulge sensitive patient information. With the present invention, patient health information is maintained in strict confidentiality, allowing a high level of compliance with patient-rights legislation in the United States and elsewhere. Of course, it should be appreciated that the bar code can alternatively not be encrypted, without departing from the invention. The prescription as printed can be hand-carried to the pharmacy by the patient. Alternatively, it can be mailed, faxed or electronically reproduced (via email or other means) into any pharmacy by either the patient or the physician's office.

As presently contemplated, the PDF-417 bar code of the present invention as shown in FIG. 2 could contain the following exemplary information:

Date: Sep. 2, 2001, Rx Number: 1234567IJXGDFOIG3465439865

Dr. Test Doctor, 123 Main Street, Libertyville, US 99999, 212-555-1212;

Patient: Test Patient, Plan: PCS538N;

Drug 1: Prozac 10 mg, qty: 300, Refills: 3;

Drug 2: Premarin 60 mg, qty: 200, Refills: 10;

Generic Substuition: Y;

Key: 9CNY5C937N398N45C5937N5C398298CY3TIY9ET07459076CTN90579875.

Preferably, the physicians, pharmacies and insurance providers would subscribe to a system for deploying and processing prescriptions in accordance with the invention. The subscription service can offer periodic variations in security and validation, through changes in encryption or other anti-forgery safeguards, by providing subscribers with ongoing updates for hardware and/or software implementations. Various levels of service can be provided even to pharmacies that do not subscribe to the system. In a subscribing pharmacy, the bar code is scanned and decrypted and all pertinent information is displayed on a monitor of a device or a computer operating a software application of the invention. For pharmacies that do not subscribe to the system, the bar code is scanned and the date the prescription was issued and validity of prescription is returned to either the present software application another type of display screen in the pharmacy. For pharmacies without a bar code capable reader or computer, the script is completely human readable, and validation is presumed either by telephone or through another means.

The present invention enables other optional features. A direct link can be electronically provided to a Prescription Benefit Manager (PBM) at an insurance provider for online drug substitution approval, thereby greatly expediting the process and increasing efficiency. Also, a link can be provided for electronic prescription dispensing, where the information is sent electronically directly to a dispensing pharmacy from a physician's office. A version of the present invention can be maintained at a physician's home for late night or other emergency prescription dispensing. Also, the prescription information can be linked to the Internet over a secure connection to the patient, for printing by the patient at a location remote from the physician's office. Of course, it should be appreciated that many other optional features may be included such as might occur, all without departing from the present invention.

As presently contemplated, the present invention includes the following principal components: a PC/104 Form Factor preferably running a Windows NT Embedded Operating System or Linux or other such system; an LCD monitor display with a Touch-Screen user interface; a bar code reader; a thermal or direct transfer printer; an optional proprietary embedded controller; an optional proprietary operating system; an optional security magnetic card reader; and an optional security proximity card reader. As presently contemplated, the prescription dispensing device of the present invention would come in two preferred embodiments. In a first embodiment, a hardware implementation would include an embedded microprocessor running either Linux or Windows NT Embedded, with an integrated LCD display having a Touch-Screen interface and a bar code reader, with a thermal or direct transfer printer for printing prescriptions. In the second preferred embodiment, a software-only application would display on the screen of a personal computer a Graphical User Interface to perform the nearly same functions as the integrated device. The software-only implementation would require the installation of an external bar code reader and printer as peripheral devices.

As described hereinabove, the present invention solves many problems associated with previous type apparatuses. However, it will be appreciated that various changes in the details, materials and arrangements of parts which have been herein described and illustrated in order to explain the nature of the invention may be made by those skilled in the are within the principle and scope of the invention will be expressed in the appended claims.

I claim:

1. A method of generating a prescription for medication comprising the steps of:
inputting patient information;
selecting a specific medication to dispense;
entering a number for the required quantity of the medication;
printing a respective prescription for the medication, wherein the prescription comprises pertinent information in a readable format as well as in a bar code.

2. The method of claim 1 wherein the step of inputting patient information comprises entering a patient name and insurance prescription plan number.

3. The method of claim 1 wherein the step of inputting patient information comprises scanning the patient information from a bar code.

4. The method of claim 1 wherein the step of selecting a specific medication comprises a step of selecting from a displayed list of authorized medications and strengths.

5. The method of claim 1 wherein, after the step of selecting, further comprising a step of displaying a preview of the patient information and prescribed medication.

6. The method of claim 1 wherein the step of entering a number further comprises selecting a number of refills available.

7. The method of claim 1 wherein, after the step of entering a number, further comprising a step of displaying a preview of the patient information, prescribed medication, drug strength, quantity, and number of refills.

8. The method of claim 7 wherein the step of displaying a preview further comprises displaying patient instructions for the prescribed medication.

9. The method of claim 1 wherein the step of printing comprises including pertinent information such as: date of dispensing; physician's name, address, phone number; physician's DEA number; patients name; prescribed medication name, strength, and quantity; specific instructions for the medication; and a unique prescription number.

10. The method of claim 1 wherein the step of printing comprises printing a preformatted high-density 2-D bar code such as a PDF-417 type bar code.

11. The method of claim 10 wherein the step of printing a pre-formatted high-density 2-D bar code comprises including information selected from a group including identifiers and encryption keys, including anti-forgery and other type security codes, passwords or other codes for enabling access to network databases for validation and other such purposes, and patient medical history information.

12. The method of claim 1 wherein the steps are implemented in accordance with a software implementation.

13. The method of claim 1 wherein the steps are implemented in accordance with a subscription service for physicians, pharmacies and insurance providers for deploying and processing prescriptions.

14. The method of claim 13 wherein the subscription service provides periodic variations in security and validation through ongoing updates for hardware and/or software implementations.

15. The method of claim 1 further comprising an electronic link for forwarding prescription information between at least one of a patient, a pharmacy, a physician, and an insurance provider with a respective other, for at least one of: directly transmitting prescription information for dispensing; and online drug substitution approval.

16. The method of claim 15 wherein the electronic link is implemented over a secure Internet connection.

17. A software implementation for generating a prescription for medication comprising:
instructions for processing an input of patient information;
instructions for processing a selection of a specific medication to dispense;
instructions for processing an entry of a number for the required quantity of the medication;
instructions for processing a print command for a respective prescription for the medication, wherein the prescription comprises pertinent information in a readable format as well as in a bar code.

18. The software implementation of claim 17 wherein the instructions for processing an input of patient information comprises processing fields for patient name and insurance prescription plan number.

19. The software implementation of claim 17 wherein the instructions for processing an input of patient information comprises processing a scan of the patient information from a bar code.

20. The software implementation of claim 17 wherein the instructions for processing a selection of specific medication comprises a processing a selection from a displayed list of authorized medications and strengths.

21. The software implementation of claim 17 wherein the instructions for processing the selection are followed by further instructions for displaying a preview of the patient information and prescribed medication.

22. The software implementation of claim 17 wherein the instructions for processing an entry step are followed by further instructions for processing a selection of a number of refills available.

23. The software implementation of claim 17 wherein the instructions for processing an entry step are followed by further instructions for displaying a preview of the patient information, prescribed medication, drug strength, quantity, and number of refills.

24. The software implementation of claim 23 wherein the instructions for displaying a preview further comprises displaying patient instructions for the prescribed medication.

25. The software implementation of claim 17 wherein the instructions for processing a print command comprises including pertinent information such as: date of dispensing; physician's name, address, phone number; physician's DEA number; patients name; prescribed medication name, strength, and quantity; specific instructions for the medication; and a unique prescription number.

26. The software implementation of claim 17 wherein the instructions for processing a print command comprises printing a pre-formatted high-density 2-D bar code such as a PDF-417 type bar code.

27. The software implementation of claim 26 wherein the instructions for processing a print command for printing a pre-formatted high-density 2-D bar code comprises including information selected from a group including identifiers and encryption keys, including anti-forgery and other type security codes, passwords or other codes for enabling access to network databases for validation and other such purposes, and patient medical history information.

28. The software implementation of claim 17 wherein the instructions are implemented in accordance with a subscription service for physicians, pharmacies and insurance providers for deploying and processing prescriptions.

29. The software implementation of claim 28 wherein the subscription service provides periodic variations in security and validation through ongoing updates for hardware and/or software implementations.

30. The software implementation of claim 17 further comprising instructions for processing an electronic link for forwarding prescription information between at least one of a patient, a pharmacy, a physician, and an insurance provider with a respective other, for at least one of: directly transmitting prescription information for dispensing; and online drug substitution approval.

31. The software implementation of claim 31 wherein the electronic link is implemented over a secure Internet connection.

32. An apparatus for generating a prescription for medication comprising:
a user interface for receiving and displaying user input;
at least one entry field for inputting patient information;
an interactive menu for selecting a specific medication to dispense;
at least one entry field for entering a number for the required quantity of the medication;
a printing component for printing a respective prescription for the medication, wherein the prescription comprises pertinent information in a readable format as well as in a bar code.

33. The apparatus of claim 32 wherein the at least one entry field for inputting patient information comprises fields for entering a patient name and insurance prescription plan number.

34. The apparatus of claim 32 wherein the user interface for receiving and displaying user input comprises a bar code scanner for scanning the patient information from a bar code.

35. The apparatus of claim 34 wherein the bar code is a pre-printed bar code.

36. The apparatus of claim 35 wherein the pre-printed bar code is printed on a health plan card issued by a patient's insurance provider.

37. The apparatus of claim 32 wherein the user interface for receiving and displaying user input comprises a personal computer using an operating system and a monitor display for displaying the respective entry fields and interactive menu.

38. The apparatus of claim 37 wherein the monitor display comprises a Touch-Screen user interface.

39. The apparatus of claim 32 further comprising at least one of a security magnetic card reader and a security proximity card reader.

40. The apparatus of claim 32 wherein the interactive menu for selecting a specific medication comprises a displayed list of authorized medications and strengths.

41. The apparatus of claim 32 wherein the at least one entry field for entering a number includes a field for selecting a number of refills available.

42. The apparatus of claim 32 wherein the user interface includes a display window displaying a preview of at least one of the patient information, prescribed medication, drug strength, quantity, and number of refills.

44. The apparatus of claim 43 wherein the display window also displays patient instructions for the prescribed medication.

45. The apparatus of claim 32 wherein the printing component comprises a thermal or direct transfer printer.

46. The apparatus of claim 32 wherein the prescription printed by the printer component comprises pertinent information such as: date of dispensing; physician's name, address, phone number; physician's DEA number; patients name; prescribed medication name, strength, and quantity; specific instructions for the medication; and a unique prescription number.

47. The apparatus of claim 32 wherein the prescription printed by the printer component comprises a pre-formatted high-density 2-D bar code such as a PDF-417 type bar code.

48. The apparatus of claim 47 wherein the pre-formatted high-density 2-D bar code comprises information selected from a group including: identifiers and encryption keys, including anti-forgery and other type security codes; passwords or other codes for enabling access to network databases for validation and other such purposes; and patient medical history information.

49. The apparatus of claim 32 wherein the apparatus is included in a subscription service for physicians, pharmacies and insurance providers for deploying and processing prescriptions.

50. The apparatus of claim 49 wherein the subscription service includes periodic variations in security and validation through ongoing updates for hardware and/or software implementations.

51. The apparatus of claim 32 further comprising an electronic link for forwarding prescription information between at least one of a patient, a pharmacy, a physician, and an insurance provider with a respective other, for at least one of: directly transmitting prescription information for dispensing; and online drug substitution approval.

52. The apparatus of claim 51 wherein the electronic link is implemented over a secure Internet connection.
